(19) United States
(12) Patent Application Publication
(10) Pub. No.: US 2024/0052797 A1
(43) Pub. Date: Feb. 15, 2024

(54) HEAT SOURCE TEMPERATURE REGULATION AND WORKING MEDIUM DETECTION FOR CLOSED-CYCLE POWER CONVERSION EQUIPMENT

(71) Applicant: Qnergy Inc., Ogden, UT (US)

(72) Inventors: David Leonard, North Ogden, UT (US); Isaac Garaway, Layton, UT (US); Ben Figlin, Farr West, UT (US); Allen A. Peterson, Eden, UT (US)

(73) Assignee: Qnergy Inc., Ogden, UT (US)

(21) Appl. No.: 18/447,530

(22) Filed: Aug. 10, 2023

Related U.S. Application Data
(60) Provisional application No. 63/396,972, filed on Aug. 11, 2022.

(51) Int. Cl. F02G 1/04

(52) U.S. Cl. CPC F02G 1/04

(57) ABSTRACT

A method for operation of a closed-cycle power conversion device includes receiving measured thermal information from one or more sensors that sense thermal characteristics of a hot portion of an absorber heat exchanger of a closed-cycle power conversion device which uses a working medium in its operation. The closed-cycle power conversion device is in thermal connection with a heat source, and absorption of heat from the heat source is proportional to a mass or mass flow rate of the working medium. If the measured thermal information is not in a defined normal range, a message is provided of an abnormality in operation of the closed-cycle power conversion device.

### FIELD OF THE INVENTION

The present invention relates to heat source temperature regulation and working medium detection for closed-cycle power conversion equipment, such as those that work on a Stirling cycle or other cycles.

### BACKGROUND OF THE INVENTION

Stirling cycle power conversion devices are one known example of closed-cycle power conversion equipment. A Stirling cycle engine is a closed cycle regenerative heat engine that operates by cyclically compressing and expanding a working medium, such as air or other gas (also called the working fluid), at different temperatures such that there is a net conversion of heat energy to mechanical work. There is typically a regenerator or absorber heat exchanger between the hot and cold portions of the engine.

It is desirable for such an engine to maintain the hot temperature at the absorber heat exchanger to optimize efficiency of the power conversion device.

Problems with either the hot temperature at the absorber heat exchanger or with the working medium, such as its mass flow (e.g., leaks may lower the mass flow), may detrimentally affect efficient operation of the power converter and the operating costs.

### SUMMARY OF THE INVENTION

The present invention seeks to provide a novel method for heat source temperature regulation and working medium detection for closed-cycle power conversion devices, as described in more detail further below. The invention is particularly applicable for Stirling cycle devices but is also applicable for other closed-cycle power conversion devices operating with other cycles, such as but not limited to, Carnot cycles, Rankine cycles, Brayton cycles, vapor-compression cycles, absorption cycles, reverse-Brayton cycles, and Hampson-Linde cycles.

There is thus provided in accordance with an embodiment of the present invention a method for operation of a closed-cycle power conversion device, the method including receiving measured thermal information from one or more sensors that sense thermal characteristics of a hot portion of an absorber heat exchanger of a closed-cycle power conversion device which uses a working medium in its operation, wherein the closed-cycle power conversion device is in thermal connection with a heat source, and absorption of heat from the heat source is proportional to a mass or mass flow rate of the working medium, and determining whether the measured thermal information is in a range defined to be a normal range, and if the measured thermal information is not in the normal range, providing a message (e.g., a warning or a prompt to perform an action) of an abnormality in operation of the closed-cycle power conversion device.

The measured thermal information may include a temperature of a structural portion of the absorber heat exchanger, or a temperature of exhaust combustion gas or other byproducts of combustion used to heat the absorber heat exchanger.

The measured thermal information may include a heat transfer rate from the heat source to the closed-cycle power conversion device.

The measured thermal information may be used to determine if the mass or mass flow rate of the working medium is lower or higher than normally expected, or to determine if the working medium is of an incorrect type or incorrect chemical composition.

### BRIEF DESCRIPTION OF DRAWINGS

The present invention will be understood and appreciated more fully from the following detailed description, taken in conjunction with the drawings in which:

FIG. 1 is a simplified block diagram of a method for operating a power conversion device, in accordance with a non-limiting embodiment of the invention.

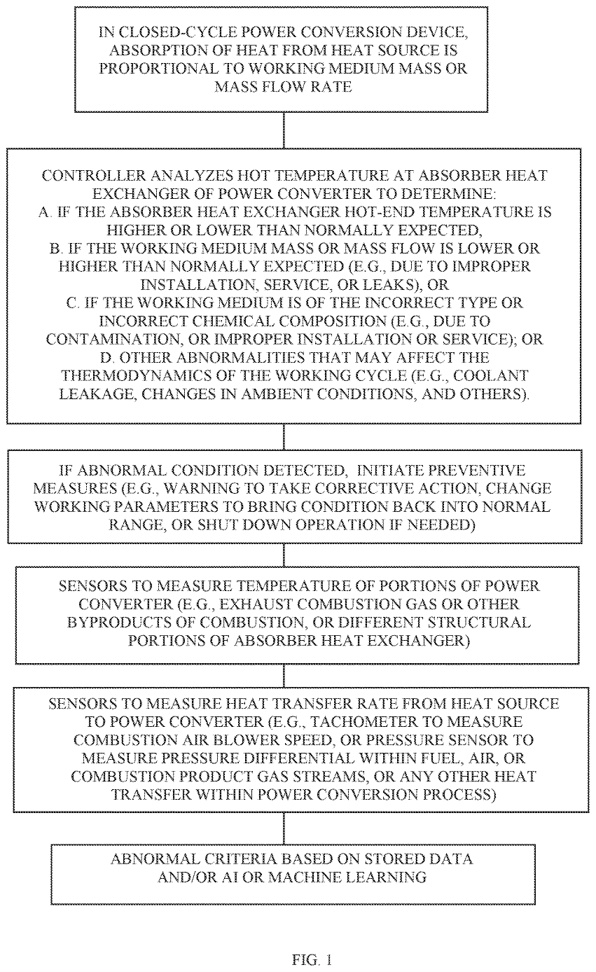

### DETAILED DESCRIPTION OF EMBODIMENTS

In an embodiment of the invention, the method uses measurement and control logic to achieve heat source temperature regulation and working medium detection and regulation in the operation of closed-cycle power conversion equipment (used for power generation or cooling or any other mode of operation). The method can detect any abnormality in the mass or mass flow rate of the working medium or any abnormality in the type of working medium. The method uses sensors to measure temperature and heat transfer rate.

Heat absorption at the absorber heat exchanger generally maintains normally expected combinations of temperature and heat transfer rate, when the power cycle working medium is normally contained within the closed cycle. The inventors have identified that for closed-cycle power conversion devices, the absorption of heat from the heat source is proportional to the working medium mass or mass flow rate.

In one embodiment of the invention, the control (such as electronic-control feedback) method used to regulate and maintain the hot temperature at the absorber heat exchanger of the power converter is additionally used to detect abnormal working medium conditions or properties by analyzing the sensed hot temperature at the absorber heat exchanger of the power converter. For example, PID-type (proportional integral derivative) electronic-control feedback methods may be used to carry out the invention.

Without limitation, for any given heat source heat transfer rate, the controller of the invention can detect:
a. if the absorber heat exchanger hot-end temperature is higher or lower than normally expected,
b. if the working medium mass or mass flow is lower or higher than normally expected (e.g., due to improper installation, service, or leaks), or
c. if the working medium is of the incorrect type or incorrect chemical composition (e.g., due to contamination, or improper installation or service); or
d. other abnormalities that may affect the thermodynamics of the working cycle (e.g., coolant leakage, changes in ambient conditions, and others).

Once an abnormal condition is detected, the controller can initiate preventive measures, such as but not limited to, issuing a warning to alert a need for taking corrective action, change working parameters to bring the condition back into the normal range, or shut down operation if needed.

The closed-cycle power conversion equipment may include a heat source, such as but not limited to, a combustion sub-system that delivers heat to be absorbed by the power converter, and a control system, which typically operates and modulates the heat transfer rate from the heat source to the power converter.

The control system may include one or more sensors to measure the temperature of important portions of the power converter, such as but not limited to, exhaust combustion gas or other byproducts of combustion which was used to heat the absorber heat exchanger, or different structural portions of the absorber heat exchanger.

The control system must include one or more sensors to measure the heat transfer rate from the heat source to the power converter, such as but not limited to, a tachometer that measures combustion air blower speed (this may provide an analog indication of the rate of fuel flow being combusted), or a pressure sensor that measures a pressure differential measurement within the fuel, air, or combustion product gas streams associated with the combustion process, or any other heat transfer within the power conversion process.

The criteria used by the control system to determine if the condition is considered abnormal may be based on stored data (e.g., data gleaned from experience, or industry accepted values, or other sources) of normally expected values of heat exchanger temperatures, heat transfer rates, working medium flow rates and properties, and others. Additionally or alternatively, the control system may use artificial intelligence and any type of machine learning methods to determine if the condition is considered abnormal.

The control system may be in communication with an electrical power management system, such as to manage the interface between user sources, loads, etc., and the electrical terminals of the power conversion device, thereby to manage voltage, current, frequency, and other electrical parameters and to manage power distribution between multiple sources and sinks, which might include batteries as either source or sink or both.

Accordingly, in one embodiment of the invention, the closed-cycle power conversion device combusts customer fuel to create a source of heat above ambient temperature. The combustion heat delivery rate is regulated to maintain a desirable target temperature within the heat source. The power conversion device absorbs heat at the heat source interface and converts the absorbed heat into electricity. During power generation operation, the electrical power manager delivers electrical power to at least one of a multiplicity of possible customer electrical load interfaces.

As noted before, the power conversion may alternatively be used for cooling. In such a case, heat is absorbed from a source below ambient temperature, and mechanical or electrical power may be supplied to cause operation of the power conversion device, which may operate as an air conditioner, cooler, heat pump, refrigerator, cryo-cooler, etc.

In any case, for all embodiments, the temperature and heat transfer rate at which the heat is delivered by the source and absorbed by the power converter are in a range defined as normal ranges of expected operating temperature and heat transfer rate. When power converter working medium is a normal type and its mass or mass flow rate is in a normal range, the relationship between the heat transfer rate delivered by the heat source and the temperature observed at the heat source interface to the power converter is well understood and predictable by both analysis and by observing data from a population of tests. The control system operating together with sensors monitors the temperature and heat transfer rate and detects any changes that are considered abnormal, that is, beyond a predefined tolerance range.

Detectable abnormal operation may occur, for example, due to improper working medium type or due to high or low medium mass or mass flow, as mentioned above. In one example, leakage of power converter working medium may cause the absorber interface temperature to rise substantially. This occurs due to the heat absorption of a closed power conversion cycle being proportional to the absorber temperature, to the medium mass or mass flow, and to the medium type. For example, in a Stirling cycle operated for power generation, leaks in the working medium will cause the pressure to drop, and for a fixed level of the heat from the source, the temperature at the heat source interface to the power converter, i.e., the absorber internal working media cycle temperature, will rise. The rise in temperature will be detected and interpreted as a sign of abnormal operation.

Once detection of abnormal occurs, the control system may implement automatic prevention countermeasures and a field service team can be notified to correct the leak proactively. In the absence of such a prevention scheme, the appliance will continue to leak working medium until it stops functioning either permanently or temporarily. Proactive repair will ensure maximal customer satisfaction.

What is claimed is:

1. A method for operation of a closed-cycle power conversion device, the method comprising:
receiving measured thermal information from one or more sensors that sense thermal characteristics of an absorber heat exchanger of a closed-cycle power conversion device which uses a working medium in its operation, wherein said closed-cycle power conversion device is in thermal connection with a heat source, and absorption of heat from the heat source is proportional to a mass or mass flow rate of the working medium; and
determining whether said measured thermal information is in a range defined to be a normal range, and if said measured thermal information is not in the normal range, providing a message of an abnormality in operation of said closed-cycle power conversion device.

2. The method according to claim 1, wherein said measured thermal information comprises a temperature of a structural portion of said absorber heat exchanger.

3. The method according to claim 1, wherein said measured thermal information comprises a temperature of exhausted heat source process gas, or other media, used in heat transfer with said absorber heat exchanger within a power generation cycle.

4. The method according to claim 1, wherein said measured thermal information comprises a heat transfer rate from said heat source to said closed-cycle power conversion device.

5. The method according to claim 1, wherein said measured thermal information is used to determine if the mass or mass flow rate of said working medium is lower or higher than normally expected.

6. The method according to claim 1, wherein said measured thermal information is used to determine if said working medium is of an incorrect type or incorrect chemical composition.

7. The method according to claim 1, wherein said heat source comprises a combustion sub-system that delivers heat to said closed-cycle power conversion device.

8. The method according to claim 1, wherein said heat source comprises a source below ambient temperature.

9. The method according to claim 1, wherein said heat source comprises a source above ambient temperature.

10. The method according to claim 4, wherein said one or more sensors comprises a tachometer that measures combustion air blower speed.

11. The method according to claim 4, wherein said one or more sensors comprises a pressure sensor that measures a pressure differential measurement associated with a combustion process or any other heat transfer within a power conversion process of said closed-cycle power conversion device.
